(19) United States
(12) Patent Application Publication
(10) Pub. No.: US 2008/0180418 A1
(43) Pub. Date: Jul. 31, 2008

(54) Liquid crystal panel control circuit having reset circuit and liquid crystal display driving circuit with same

(75) Inventor: Zhan-Wei Fu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/011,653

(22) Filed: Jan. 28, 2008

(30) Foreign Application Priority Data
Jan. 26, 2007 (CN) 200710073125.7

(51) Int. Cl. G09G 5/00

(52) U.S. Cl. 345/204

(57) ABSTRACT

An exemplary liquid crystal panel control circuit (20) includes a direct current converting circuit (23). The direct current converting circuit includes a comparator (231), a reset circuit (232), and a DC-to-DC converting circuit (233) connected in series. The liquid crystal panel control circuit can return to an initial status from a protection status by the reset circuit.

### FIELD OF THE INVENTION

The present invention relates to liquid crystal panel control circuits, and especially to a liquid crystal panel control circuit having a comparator and a reset circuit, and a liquid crystal display driving circuit including the control circuit.

### GENERAL BACKGROUND

A typical LCD has the advantages of portability, low power consumption, and low radiation. LCDs have been widely used in various portable information products, such as notebooks, personal digital assistants (PDAs), video cameras and the like. Furthermore, the LCD is considered by many to have the potential to completely replace CRT (cathode ray tube) monitors and televisions. Driving circuits are essential components for driving the LCDs.

Referring to FIG. 2, a typical LCD driving circuit 1 includes a system control circuit 19 and a liquid crystal panel control circuit 10. The liquid crystal panel control circuit 10 includes a timing control circuit 16, and a DC-to-DC converting circuit 13. The system control circuit 19 is configured for providing data signals for the timing control circuit 16, and providing direct current voltages for the timing control circuit 16 and the DC-to-DC converting circuit 13 respectively. The timing control circuit 16 is configured for providing the received data signals to a liquid crystal panel (not shown). The DC-to-DC converting circuit 13 is configured for providing the received direct current voltages to integrated circuits (ICs) (not shown) connected thereto.

The system control circuit 19 includes a plurality of data signal output terminals 192 and a direct current voltage output terminal 191. The data signal output terminals 192 are connected to the timing control circuit 16 via a plurality of data signal lines 18. The direct current voltage output terminal 191 is connected to the timing control circuit 16 and the DC-to-DC converting circuit 13 respectively. And the timing control circuit 16 is connected to the DC-to-DC converting circuit 13.

The direct current voltage output terminal 191 outputs a direct current voltage Vc, and the data signal output terminals 192 output pulse voltages Vd. A value of the direct current voltage Vc is equal to a value of the pulse voltages Vd.

The timing control circuit 16 includes a plurality of electro static discharge (ESD) lines 161 in parallel. Each of the ESD lines 161 includes a first diode 162 and a second diode 163 connected in series. Negative electrodes of the first diodes 162 are connected to the direct current voltage output terminal 191 of the system control circuit 19. Positive electrodes of the second diodes 163 are connected to ground. Each of the data signal lines 18 is connected to a positive electrode of a corresponding first diode 162.

The DC-to-DC converting circuit 13 has a protection status. When the DC-to-DC converting circuit 13 receives a direct current voltage less than a direct current working voltage thereof, the DC-to-DC converting circuit 13 comes into the protection status from an initial status. In such a case, even a normal direct current working voltage is provided to the DC-to-DC converting circuit 13, the DC-to-DC converting circuit 13 is still in the protection status, and does not work.

At the instant of starting the an LCD, if the system control circuit 19 outputs direct current voltages to the liquid crystal panel control circuit 10 firstly, the direct current voltage converting circuit 13 can work normally. If the system control circuit 19 outputs data signals to the liquid crystal panel control circuit 10 firstly, the pulse voltage Vd of the data signals is dropped 0.7V by the first diode 162 of the timing control circuit 16. And the dropped pulse voltage Vd is transferred to the DC-to-DC converting circuit 13. Thus the DC-to-DC converting circuit 13 comes into a protection status, and does not work even the direct current voltage Vc is provided to the DC-to-DC converting circuit 13 after a short time. Thus, the DC-to-DC converting circuit 13 can not work normally. Therefore, the liquid crystal panel control circuit 10 can not work normally.

To make sure the direct current voltage is provided firstly, a design of the system control circuit 19 is complicated, and accordingly a cost is increased.

What is needed, therefore, is a liquid crystal panel control circuit that can overcome the above-described deficiencies.

### SUMMARY

In one preferred embodiment, a liquid crystal panel control circuit includes a direct current converting circuit. The direct current converting circuit includes a comparator, a reset circuit, and a DC-to-DC converting circuit connected in series.

Other novel features and advantages will become more apparent from the following detailed description when taken in conjunction with the accompanying drawings.

### BRIEF DESCRIPTION OF THE DRAWINGS

FIG. 1 is essentially an abbreviated circuit block diagram of an LCD driving circuit according to an exemplary embodiment of the present invention.

FIG. 2 is essentially an abbreviated circuit block diagram of a conventional LCD driving circuit.

### DETAILED DESCRIPTION OF PREFERRED EMBODIMENTS

Reference will now be made to the drawing figures to describe various embodiments of the present invention in detail.

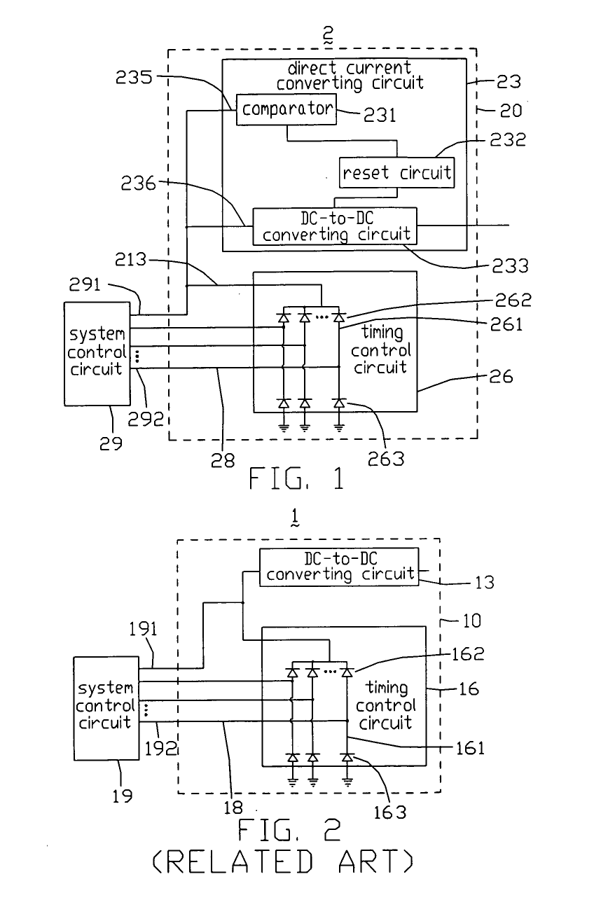

Referring to FIG. 1, an LCD driving circuit 2 according to an exemplary embodiment of the present invention is shown, the driving circuit 2 generally used in an LCD. The LCD driving circuit 2 includes a system control circuit 29 and a liquid crystal panel control circuit 20. The liquid crystal panel control circuit 20 includes a timing control circuit 26 and a direct current converting circuit 23.

The system control circuit 29 is configured for providing data signals for the timing control circuit 26, and providing direct current voltages for the timing control circuit 26 and the direct current converting circuit 23 respectively. The timing control circuit 26 is configured for providing the received data signals to a liquid crystal panel (not shown). The direct current converting circuit 23 is configured for providing the received direct current voltages to integrated circuits (ICs) (not shown) connected thereto.

The system control circuit 29 includes a plurality of data signal output terminals 292 and a direct current voltage output terminal 291. The data signal output terminals 292 are connected to the timing control circuit 26 via a plurality of data signal lines 28. The direct current voltage output terminal 291 is connected to the timing control circuit 26 and the direct current converting circuit 23 respectively. And the timing control circuit 26 is connected to the direct current converting circuit 23.

The direct current voltage output terminal 291 outputs a direct current voltage Vc, and the data signal terminals 292 output pulse voltages Vd. A value of the direct current voltage Vc is equal to a value of the pulse voltages Vd.

The direct current converting circuit 23 includes a DC-to-DC converting circuit 233, a comparator 231, and a reset circuit 232. A first input terminal 235 of the DC-to-DC converting circuit 233 and a second input terminal 236 of the comparator 231 are both connected to the direct current voltage output terminal 291 of the system control circuit 29. An output terminal of the comparator 231 is connected to an input terminal of the reset circuit 232. An output terminal of the reset circuit 232 is connected to a reset control terminal of the DC-to-DC converting circuit 233.

The DC-to-DC converting circuit 233 has a protection status. When the DC-to-DC converting circuit 233 receives a direct current voltage less than a direct current working voltage thereof, the DC-to-DC converting circuit 233 comes into the protection status from an initial status. In such a case, even a normal direct current working voltage is provided to the DC-to-DC converting circuit 233, the DC-to-DC converting circuit 233 is still in the protection status, and does not work normally.

The timing control circuit 26 includes a plurality of electro static discharge (ESD) lines 261 in parallel. Each of the ESD lines 261 includes a first diode 262 and a second diode 263 connected in series. Negative electrodes of the first diodes 262 are connected to the direct current voltage output terminal 291 of the system control circuit 29. Positive electrodes of the second diodes 263 are connected to ground. Each of the data signal lines 28 is connected to a positive electrode of a corresponding first diode 262.

The comparator 231 has a predetermined reference voltage Vr, and the reference voltage Vr satisfies a relationship: Vc-0.7V<Vr<Vc, wherein 0.7V is a voltage drop when the first diodes 262 are turned on. And preferably, the reference voltage Vr is in the range from (Vc-0.5V) to (Vc-0.2V). When the first input terminal 235 of the comparator 231 receives a direct current voltage less than the reference voltage Vr, the comparator 231 outputs a low level voltage to the reset circuit 232. The reset circuit 232 does not work at the low level voltage. When the first input terminal 235 of the comparator 231 receives a direct current voltage greater than the reference voltage Vr, the comparator 231 outputs a high level voltage to the reset circuit 232. In such a case, the reset circuit 232 outputs a high level voltage to the reset control terminal of the DC-to-DC converting circuit 233. Then the DC-to-DC converting circuit 233 is returned to the initial status.

At the instant of starting the LCD, if the system control circuit 29 outputs direct current voltages to the liquid crystal panel control circuit 20 firstly, the direct current voltage converting circuit 23 can work normally. If the system control circuit 29 outputs data signals to the liquid crystal panel control circuit 20 firstly, the pulse voltage Vd of the data signals is dropped 0.7V by the first diode 262 of the timing control circuit 26. The dropped pulse voltage Vd is transferred to the DC-to-DC converting circuit 233. Thus the DC-to-DC converting circuit 233 comes into the protection status, and does not work normally. That is, the DC-to-DC converting circuit 233 can not output desired direct current voltages to the ICs connected thereto.

However, after a short time, when the direct current voltage output terminal 291 starts to output the direct current voltage Vc to the direct current converting circuit 23, the comparator 231 receives the direct current voltage Vc, and then outputs a high level voltage to the reset circuit 232. The reset circuit outputs a high level voltage to the reset control terminal of the DC-to-DC converting circuit 233. Thus, the DC-to-DC converting circuit 233 returns to the initial status. When the second input terminal 236 receives the delayed direct current voltage Vc, the DC-to-DC converting circuit 233 works normally, and outputs desired direct current voltages to the ICs connected thereto.

Because the direct current converting circuit 23 includes the reset circuit 232, when the DC-to-DC converting circuit 233 comes into the protection status at the startup of the LCD, the reset circuit 232 can output a high level voltage for returning the DC-to-DC converting circuit 233 to the initial status. After that, when the delayed direct current voltage is provided to the DC-to-DC converting circuit 233, the DC-to-DC converting circuit 233 can work normally.

Unlike a conventional liquid crystal panel control circuit, the direct current converting circuit 23 can return to the initial status from the protection status by the reset circuit 232. Thus, even data signals are provided firstly, the direct current converting circuit 23 can work normally without restarting an LCD. What is more, when an LCD driving circuit uses the liquid crystal panel control circuit 20, the system control circuit 29 can be designed freely. That is, when the system control circuit 29 is designed, the designer needs not to make sure that the direct current voltage is outputted firstly. Even data signals are provided firstly, the liquid crystal panel control circuit 20 can work normally. Therefore, the design of the system control circuit 29 is simplified. Accordingly, a cost of the LCD driving circuit 2 is reduced.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal panel control circuit, comprising:
a direct current converting circuit, the direct current converting circuit comprising a comparator, a reset circuit, and a DC-to-DC converting circuit connected in series.

2. The liquid crystal panel control circuit as claimed in claim 1, wherein the comparator has a predetermined reference voltage, if the comparator receives a direct current voltage lower than the reference voltage, the comparator outputs a low level voltage to the reset circuit, and the reset circuit does not work, if the comparator receives a direct current voltage higher than the reference voltage, the comparator outputs a high level voltage to the reset circuit, and the reset circuit outputs a high level voltage to reset the DC-to-DC converting circuit, that is, the DC-to-DC converting circuit is returned to an initial status.

3. The liquid crystal panel control circuit as claimed in claim 2, further comprising a timing control circuit connected to the direct current converting circuit.

4. The liquid crystal panel control circuit as claimed in claim 3, wherein the timing control circuit comprises a plurality of electro static discharge (ESD) lines, each ESD line comprising a first diode and a second diode in series, positive electrodes of the second diodes being connected to ground, negative electrodes of the first diodes are connected to the direct current converting circuit.

5. The liquid crystal panel control circuit as claimed in claim 4, wherein the predetermined reference voltage satisfies a relationship: Vc-0.7V<Vr<Vc, wherein Vc represents direct current voltage when the DC-to-DC converting circuit works normally, Vr represents the predetermined reference voltage, 0.7V is equal to a voltage drop when the first diodes are turned on.

6. The liquid crystal panel control circuit as claimed in claim 2, wherein a plurality of data signals are provided to the timing control circuit, and the data signals are pulse voltages.

7. A liquid crystal display (LCD) driving circuit, comprising:
a liquid crystal panel control circuit; and
a system control circuit configured for providing data signals and direct current voltages to the liquid crystal panel control circuit;
the liquid crystal panel control circuit comprising a timing control circuit, a direct current converting circuit, both connected to an direct current voltage output terminal of the system control circuit, the direct current converting circuit comprising a comparator, a reset circuit, and a DC-to-DC converting circuit connected in series.

8. The LCD driving circuit as claimed in claim 7, wherein the comparator comprises a predetermined reference voltage, when the comparator receives a direct current voltage less than the reference voltage, the comparator outputs a low level voltage to the reset circuit, when the comparator receives a direct current voltage greater than the reference voltage, the comparator outputs a high level voltage to the reset circuit.

9. The LCD driving circuit as claimed in claim 8, wherein when the reset circuit receives a low level voltage, the reset circuit does not work, when the reset circuit receives a high level voltage, the reset circuit provides a high voltage to reset the DC-to-DC converting circuit, that is, the DC-to-DC converting circuit is returned to an initial status.

10. The LCD driving circuit as claimed in claim 9, wherein the timing control circuit comprises a plurality of electro static discharge (ESD) lines, each ESD line comprising a first diode and a second diode in series, positive electrodes of the second diodes being connected to ground, negative electrodes of the first diodes are connected to the direct current converting circuit.

11. The LCD driving circuit as claimed in claim 10, wherein the predetermined reference voltage satisfies a relationship: Vc-0.7V<Vr<Vc, wherein Vc represents direct current voltage when the DC-to-DC converting circuit works normally, Vr represents the predetermined reference voltage, 0.7V is equal to a voltage drop when the first diode is turned on.

12. The LCD driving circuit as claimed in claim 10, wherein the system control circuit comprises a direct current output terminal and a plurality of data signal output terminals, each data signal output terminal is connected to a positive electrode of the first diode of a corresponding ESD line.

13. The LCD driving circuit as claimed in claim 12, wherein the data signal output terminals output pulse voltages, the direct current output terminal outputs a direct current voltage, amplitude of the pulse voltage is equal to a value of the direct current voltage.

14. A liquid crystal panel control circuit, comprising:
a direct current converting circuit, the direct current converting circuit comprising a reset circuit, and a DC-to-DC converting circuit, the DC-to-DC converting circuit having an initial status and a protection status, when the DC-to-DC converting circuit coming into the protection status, the reset circuit resetting the DC-to-DC converting circuit to the initial status.

15. The liquid crystal panel control circuit as claimed in claim 14, wherein the direct current converting circuit further comprises a comparator connected to the reset circuit, the comparator has a predetermined reference voltage.

16. The liquid crystal panel control circuit as claimed in claim 15, wherein when the comparator receives a direct current voltage greater than the reference voltage, the comparator controls the reset circuit output a reset control signal to return the DC-to-DC converting circuit to the initial status.
